(19) United States
(12) Patent Application Publication
(10) Pub. No.: US 2024/0017624 A1
(43) Pub. Date: Jan. 18, 2024

(54) Dynamic Air Charging System

(71) Applicant: Marshall Bailey, Hayward, CA (US)

(72) Inventor: Marshall Bailey, Hayward, CA (US)

(21) Appl. No.: 17/803,446

(22) Filed: Jul. 12, 2022

(51) Int. Cl. B60L 8/00; F03D 9/25

(52) U.S. Cl. CPC B60L 8/006; F03D 9/25

(57) ABSTRACT

The dynamic air charging system is a device that will allow a vehicle to charge its main power supply while in use/motion. This is achieved by using kinetic air flow (via the forward motion of a vehicle) into fixed or flex chambers across an inline fan motor. Which will produce a charge that is distributed to a vehicle primary or auxiliary battery array.

### BACKGROUND OF THE INVENTION

### 1. Field of the Invention

A dynamic air charging system allows for an electric vehicle to self/auto charge itself while in use.

### 2. Description of Related Art

The most advanced charging systems used today for electric vehicles consist primarily of two methods. The first is passive braking charge and the second is remote stationary charging. Both methods do not increase the initial travel range of a vehicle which is roughly between 250 to 450 miles and this range is substantially decreased if the operating speed is increased.

### BRIEF DESCRIPTION OF THE SEVERAL VIEWS OF THE DRAWINGS

FIG. 1 is a side perspective view of an air charging system.

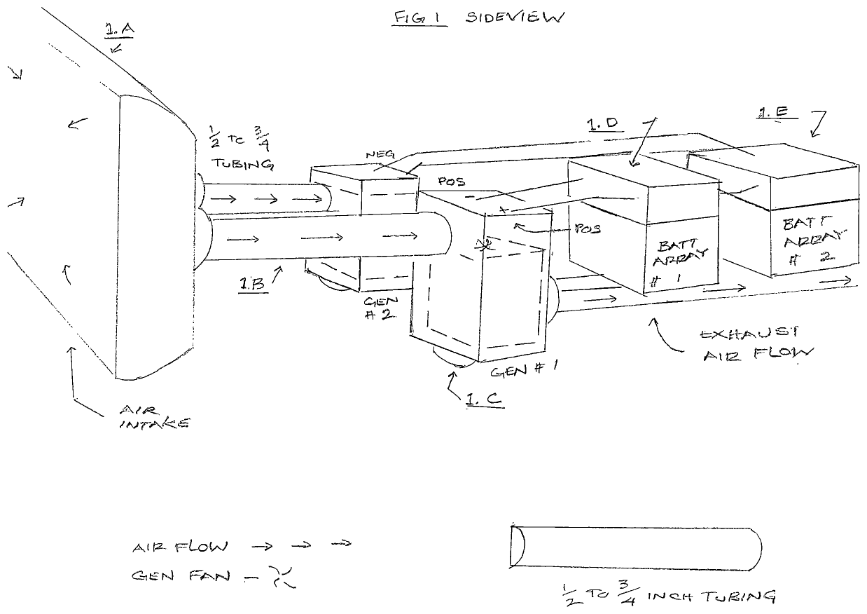

FIG. 2 is a top view of the air charging system of FIG. 1.

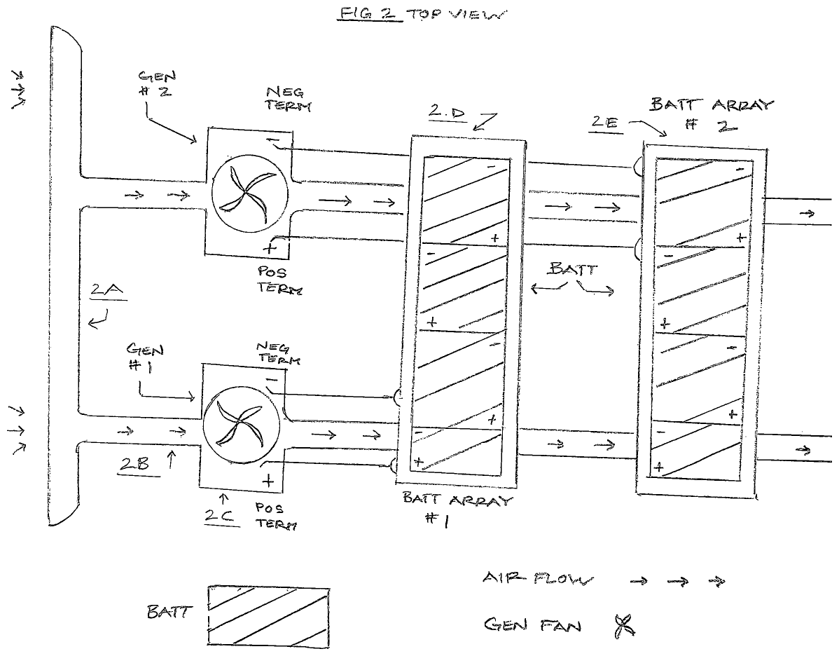

FIG. 3 is a side elevation view of a vehicle housing the air charging system of FIGS. 1 and 2.

### DETAILED DESCRIPTION OF THE INVENTION

The Dynamic air charging system will allow the vehicle to self-charge while in use. This will eliminate the need for both passive charging and remote charging. And should give the vehicle almost unlimited range and eliminate the need for conservative speeds to achieve maximum range/distance.

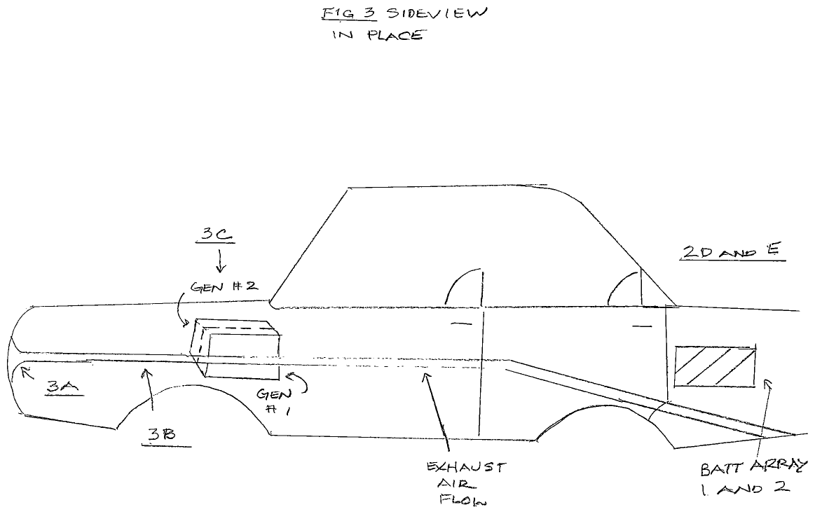

Dynamic charging is achieved through the forward motion of a vehicle (FIG. 3) which will allow for continual in motion charging. The channeled/harnessed air will flow through fixed or flex channeling (2a and 2b) then passes over a fan motor assembly (2c) which will cause the fan to turn and excite the coil and produce and electrical current. The current can then be applied directly to the primary battery array (2d) or to the auxiliary battery array (2e.).

1. The dynamic air charging system is comprised of inducting air through dedicated hollow chambers over a fixed inline fan and motor (turbine/coil) causing the fan blade to turn thus generating a charge that is connected via wiring to the primary or auxiliary battery arrays.

2. The dynamic air charging system article of claim 1. Where as the inducted air, via the forward motion of a vehicle, is forced through the forward port in the front of the vehicle.

3. The dynamic air charging system article of claim 2. Whereas the inducted/forced air is pushed along the hollow chambers and into a fan blade motor/turbine assembly causing the blade to turn and excite the coil to produce an electrical current.

4. The dynamic air charging system of claim 3. Wherein the mechanically generated charge/current is circulated via insulated wiring to the primary or auxiliary battery array.

5. The dynamic air charging system of claim 4. Whereas the selected online batteries are switched to off and the auxiliary batteries or switched to on/charge. The offline batteries are then re-charged by the auxiliary batteries. Once the primary batteries have reached full charge they are placed back online and then the next set of selected batteries will begin the process.
